(19) United States
(12) Patent Application Publication
(10) Pub. No.: US 2012/0222272 A1
(43) Pub. Date: Sep. 6, 2012

(54) FLY BALL SYSTEM

(76) Inventor: Wesley Moreland, Pine Island, MN (US)

(21) Appl. No.: 13/330,878

(22) Filed: Dec. 20, 2011

Related U.S. Application Data
(60) Provisional application No. 61/448,675, filed on Mar. 3, 2011.

(51) Int. Cl. A44B 19/26; B23P 11/00; G09F 3/16

(52) U.S. Cl. 24/385; 40/299.01; 29/428

(57) ABSTRACT

A fly ball system comprising: a zipper assembly; a removeably-attachable tag having an eye; and an attacher removeably inserted through the eye. The zipper includes a zipper; a top tape extension; a top stop; a slider; a pull tab; a tape; a bottom stop; an insertion pin; and a retainer box. The zipper, the top tape extension, the top stop, the slider, the pull tab, the tape, the bottom stop, the insertion pin, and the retainer box form the zipper assembly for temporarily joining two edges of fabric together. The attacher includes a clip and is removeably-attached via an opening/closing mechanism to an interior cut-out located on a front portion of the pull tab on the slider of the zipper assembly. The attacher removeably-attaches the eye on the removeably-attachable tag to the pull tab on the slider of the zipper assembly for replacing existing broken zipper tabs.

### CROSS-REFERENCE TO RELATED APPLICATION

The present application is related to and claims priority from prior provisional application Ser. No. 61/448,675, filed Mar. 3, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of zipper attachments and more specifically relates to a removeably-attachable tag attachable to a pull tab on a zipper.

### 2. DESCRIPTION OF THE RELATED ART

A zipper is a commonly used device for temporarily joining two edges of fabric together. Zippers may be used in clothing including jackets and jeans, luggage, bags, sporting goods, camping gear, and other daily use items. A zipper typically consists of two strips of fabric tape, each affixed to one of the two pieces to be joined, carrying from tens to hundreds of specially shaped metal or plastic teeth that are designed to mesh with the adjoining side of teeth. These teeth can be either individual or shaped from a continuous coil, and are also referred to as elements. The slider, operated by hand, moves along the rows of teeth. Inside the slider is a Y-shaped channel that meshes together or separates the opposing rows of teeth, depending on the direction of the slider's movement.

Zippers may increase or decrease the size of an opening to allow or restrict the passage of objects, as in the fly of trousers or in a pocket. Further, zippers may join or separate two ends or sides of a single garment, as in the front of a jacket, dress or skirt. Zippers may also attach or detach a separable part of the garment to or from another, as in the conversion between trousers and shorts or the connection/disconnection of a hood and a coat. These variations are achieved by sewing one end of the zipper together, sewing both ends together, or allowing both ends of the zipper to fall completely apart.

A zipper costs relatively little, but if it fails, the garment may be unusable until the zipper is repaired or replaced—which may be quite inconvenient and potentially expensive. Problems often lie with the zipper slider; when it becomes worn it may not properly align and join the alternating teeth. If a zipper fails, it can either jam, stick or partially break off. This normally renders the garment in a partially zipped condition, unsuitable for inclement weather.

Zippers may also possess very small pull tabs, making them difficult to see or to hold onto. Unfortunately zippers with small pull tabs may cause problems when individuals are trying to dress or undress themselves. Some clothing items may have zippers that are placed in difficult positions, putting the zippers' small pull tab further out of reach. In these cases, individuals may need assistance from other people while getting dressed or undressed. If help is not available, individuals may spend considerable amounts of time trying to access the zippers themselves, which may be frustrating.

Various attempts have been made to solve problems found in the zipper art. Among these are found in: U.S. Pat. No. 6,026,546; D372,440; U.S. Pat. No. 4,704,770; U.S. Pat. No. 7,454,819; U.S. Pat. No. 5,416,951. This prior art is representative of zipping means.

None of the above inventions and patents, taken either singly or in combination, is seen to describe the invention as claimed. Thus, a need exists for a removeably-attachable tag attached to a pull tab of a zipper to facilitate ease of locating and grasping the pull tab on the zipper so that the zipper may be opened or closed with relative ease and to avoid the above-mentioned problems.

### BRIEF SUMMARY OF THE INVENTION

In view of the foregoing disadvantages inherent in the known attacher art, the present invention provides a novel fly ball system. The general purpose of the present invention, which will be described subsequently in greater detail is to provide a removeably-attachable tag attachable to a pull tab of a zipper to facilitate ease of locating and grasping the pull tab on the zipper so that the zipper may be reliably opened or closed with ease.

A fly ball system is disclosed herein, a preferred embodiment comprising: a zipper assembly; a removeably-attachable tag having an eye; and an attacher removeably inserted through the eye. The zipper assembly preferably includes a zipper; a top tape extension; a top stop; a slider; a pull tab; a tape; a bottom stop; an insertion pin; and a retainer box. The zipper, the top tape extension, the top stop, the slider, the pull tab, the tape, the bottom stop, the insertion pin, and the retainer box form the zipper assembly for temporarily joining two edges of fabric together (via zipping/unzipping actions.)

The attacher is removeably-attached via an opening/closing mechanism to an interior cut-out located on a front portion of the pull tab on the slider of the zipper assembly. The attacher may be a clip and preferably measures approximately ⅞-inch. The attacher removeably-attaches the eye on the removeably-attachable tag to the pull tab on the slider of the zipper assembly. The eye is circular and is affixed onto the removeably-attachable tag. The eye is then integral with the removeably-attachable tag. The removeably-attachable tag acts as a lever arm whereby a user can locate, grasp and manipulate the zipper upwardly and downwardly to open and close the zipper. The removeably-attachable tag comprises plastic along with a logo in preferred embodiments; however other materials/designs may be used.

A kit is also described herein including a including plurality of removeably-attachable tags; a plurality of attachers; and a set of user installation instructions.

A method of using a pull tab attachment for a slide fastener system comprising the steps of: choosing a removeably-attachable tag having an eye; choosing an attacher; inserting the attacher through the eye of the removeably-attachable tag; attaching the attacher to a pull tab on a slider of a zipper assembly; zipping the garment via a zipper on the zipper assembly; and unzipping the garment via the zipper on the zipper assembly.

The present invention holds significant improvements and serves as a fly ball system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, fly ball system constructed and operative according to the teachings of the present invention.

FIG. 1 shows a perspective view illustrating a fly ball system in an ‘in-use’ condition according to an embodiment of the present invention.

FIG. 2A is a perspective view illustrating a pull tab attachment for a slide fastener of the fly ball system according to an embodiment of the present invention.

FIG. 2B is a perspective view illustrating another design of pull tab attachment for a slide fastener of the fly ball system according to an embodiment of the present invention.

FIG. 3A is a perspective view illustrating yet another design of the pull tab attachment for a slide fastener of the fly ball system according to an embodiment of the present invention.

FIG. 3B is a perspective view illustrating a pull tab attachment for a slide fastener of the fly ball system according to an embodiment of the present invention.

FIG. 4 is a perspective view illustrating the pull tab attachment for a slide fastener removeably-attached to a bag of the fly ball system according to an embodiment of the present invention.

FIG. 5 is a flowchart illustrating a method of use according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a zipper device and more particularly to a removeably-attachable tag attachable to a pull tab of a zipper to facilitate ease of locating and grasping the pull tab on the zipper so that the zipper may be opened or closed. The device is also convenient for replacement of broken pull tabs.

Generally speaking, fly ball system allows consumers to quickly locate and securely grasp zipper tongues when dressing and undressing. The invention may comprise a small tag-like item made of plastic, wood, or other suitable material. At the top of the tag can be a clip measuring approximately ⅞″, designed to secure the invention to the end of a zipper tongue. The tag may be constructed to resemble a sports team logo, allowing individuals to show support and enthusiasm for their favorite sports teams. Other designs and shapes corresponding with different themes can also be applied to the invention. This invention may be interchangeable in design, allowing consumers to easily switch one tag for another of a different design.

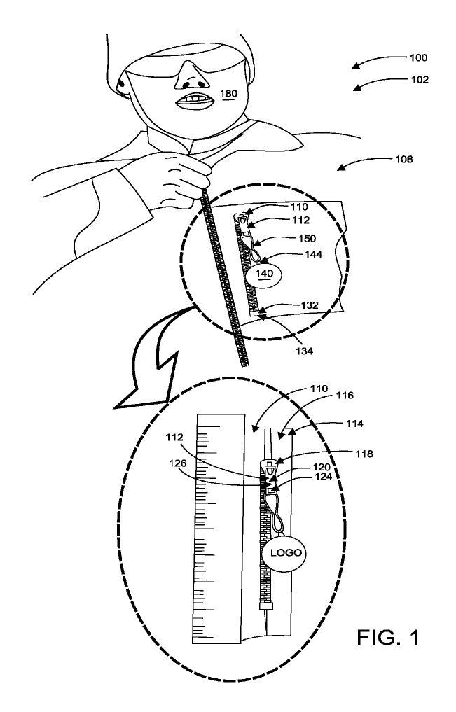

Now referring to the drawings by numerals of reference there is shown in FIG. 1, a perspective view illustrating fly ball system 100 (pull tab attachment for a slide fastener system) in ‘in-use’ condition 106 according to an embodiment of the present invention.

Fly ball system 100 preferably comprises pull tab attachment for a slide fastener 102. Pull tab attachment for a slide fastener 102 in a preferred embodiment comprising: zipper assembly 110; removeably-attachable tag 140 having eye 144; and attacher 150 removeably inserted through eye 144. The zipper assembly 110 includes zipper 112; top tape extension 114; top stop 116; slider 118; pull tab 122; tape 128; bottom stop 130; insertion pin 132; and retainer box 134. Zipper 112, top tape extension 114, top stop 116, slider 118, pull tab 122, tape 128, bottom stop 130, insertion pin 132, and retainer box 134 form zipper assembly 110 for temporarily joining two edges of fabric together.

Attacher 150 is removeably-attached via an opening/closing mechanism to interior cut-out 124 located on front portion 126 of pull tab 122 on slider 118 of zipper assembly 110. Attacher 150 removeably-attaches eye 144 on removeably-attachable tag 140 to pull tab 122 on slider 118 of zipper assembly 110. Eye 144 is preferably (semi) circular in shape. Eye 144 is preferably coupled to removeably-attachable tag 140. Eye 144 in this way may become integral with removeably-attachable tag 140. Upon reading this specification, it should be appreciated that, under appropriate circumstances, considering such issues as user preferences, design preference, structural requirements, marketing preferences, cost, available materials, technological advances, etc., other eye shapes such as, for example, oval, oblong, etc may be sufficient.

Attacher 150 preferably comprises a clip. The clip measures approximately ⅞-inch. However, it should be appreciated that other lengths and diameters will fall within the scope and spirit of the invention as described herein, and that any references to sizes, lengths, and weights are exemplary, and are not to be construed as limiting in any way. Upon reading this specification, it should be appreciated that, under appropriate circumstances, considering such issues as user preferences, design preference, structural requirements, marketing preferences, cost, available materials, technological advances, etc., other attachers such as, for example, clasps, hooks, and the like etc may be sufficient.

Removeably-attachable tag 140 acts as a lever arm whereby user 180 can locate, grasp and manipulate zipper 112 upwardly and downwardly to open and close zipper 112. This action creates zipping and unzipping for use with garments and other items serviced by zippers.

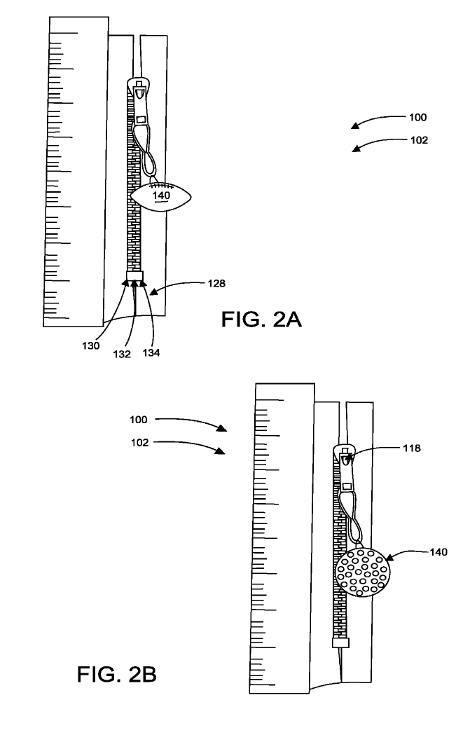

Referring now to FIG. 2A-2B, illustrating perspective views illustrating pull tab attachment for a slide fastener 102 of fly ball system 100 according to an embodiment of the present invention.

Removeably-attachable tag 140 comprises plastic material in preferred embodiments. Upon reading this specification, it should be appreciated that, under appropriate circumstances, considering such issues as user preferences, design preference, structural requirements, marketing preferences, cost, available materials, technological advances, etc., other material arrangements such as, for example, rubber, ferrous and non-ferrous materials, etc may be sufficient and fall within the scope of the present invention provided herewithin.

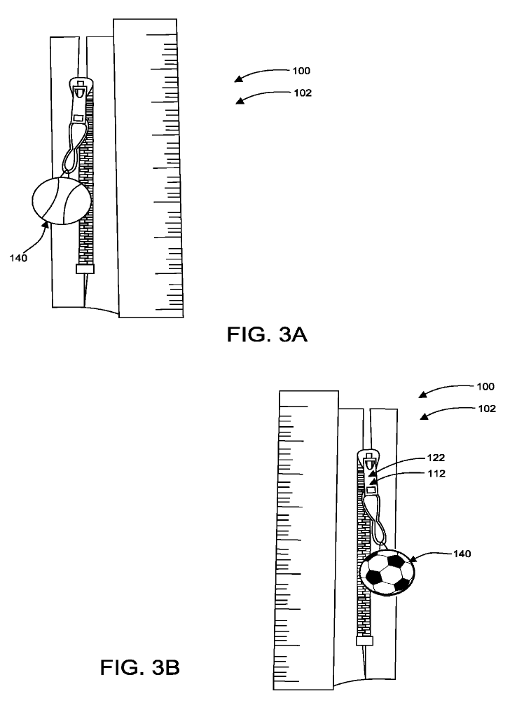

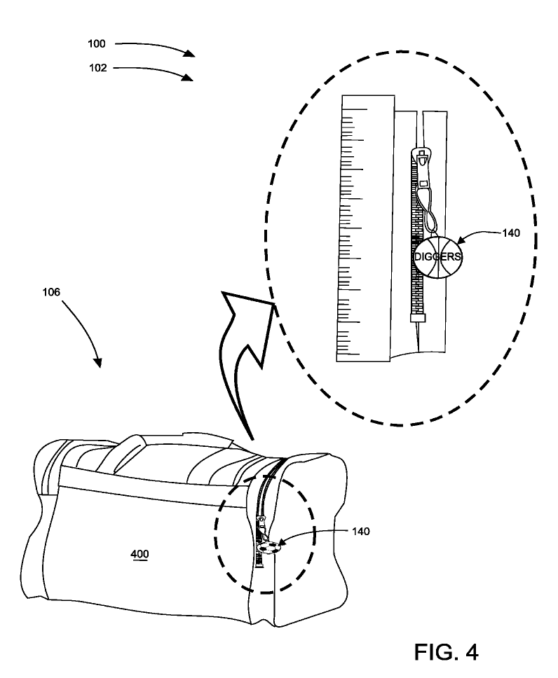

Removeably-attachable tag 140 may also comprise a logo, indicia, or a sports theme such as illustrated in FIGS. 2A-4. Removeably-attachable tag 140 comprises a football theme as shown in FIG. 2A; a golf ball theme as shown in FIG. 2B; a baseball theme as shown in FIG. 3A; a soccer ball theme as shown in FIG. 3B; and a basketball theme as shown in FIG. 4. Upon reading this specification, it should be appreciated that, under appropriate circumstances, considering such issues as user preferences, design preference, structural requirements, marketing preferences, cost, available materials, technological advances, etc., other sports themes and indicia of removeably-attachable tag such as, for example, tennis balls, bowling balls billiard balls, advertisements, team names, etc may be sufficient.

Referring now to FIG. 4 illustrating a perspective view of pull tab attachment for a slide fastener 102 of the fly ball system 100 removeably-attached to bag 400. Pull tab attachment for slide fastener 102 is not limited to use only on garments such as clothing apparel as shown in the previous figures. Pull tab attachment for a slide fastener 102 may also be removeably-attached to items such as bag 400. Upon reading this specification, it should be appreciated that, under appropriate circumstances, considering such issues as user preferences, design preference, structural requirements, marketing preferences, cost, available materials, technological advances, etc., other garments and non-garments such as, for example, purses, jewelry, toys, etc may be sufficient.

Kit 450 may include a plurality of removeably-attachable tags 140; a plurality of attachers 150; and a set of user installation instructions for use on garments and non-garments. Fly ball system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized colors/designs, parts may be sold separately, etc., may be sufficient.

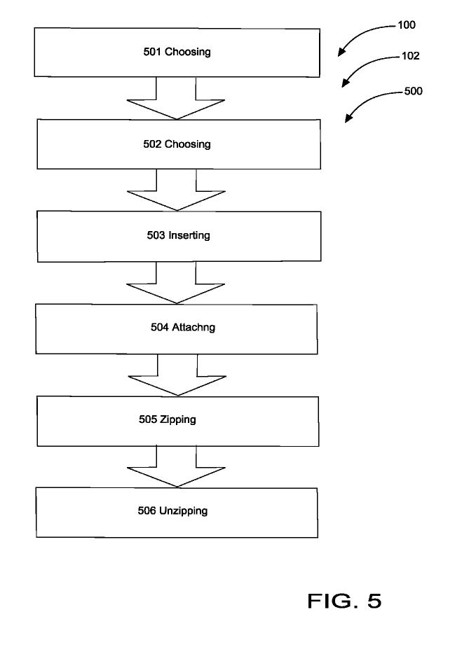

Referring now to FIG. 5, a flowchart 550 illustrating a method of using (method of use 500) fly ball system 100 according to an embodiment of the present invention of FIGS. 1-4.

A method of using (enabling method of use 500) fly ball system 100 preferably comprises the steps of: step one 501 choosing removeably-attachable tag 140 having eye 144; step two 502 choosing attacher 150; step three 503 inserting attacher 150 through eye 144 of removeably-attachable tag 140; step four 504 attaching attacher 150 to pull tab 122 on slider 118 of zipper assembly 110; step five 505 zipping the garment via zipper 112 on zipper assembly 110; and step six 506 unzipping the garment via zipper 112 on zipper assembly 110.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pull tab attachment for a slide fastener system comprising:
a zipper assembly having;
a zipper;
a top tape extension;
a top stop;
a slider;
a pull tab;
a tape;
a bottom stop;
an insertion pin; and
a retainer box;
a removeably-attachable tag having an eye;
an attacher removeably inserted through said eye;
wherein said zipper, said top tape extension, said top stop, said slider, said pull tab, said tape, said bottom stop, said insertion pin, and said retainer box form said zipper assembly for temporarily joining two edges of fabric together;
wherein said attacher is removeably-attached via an opening/closing mechanism to an interior cut-out located on a front portion of said pull tab on said slider of said zipper assembly;
wherein said attacher removeably-attaches said eye on said removeably-attachable tag to said pull tab on said slider of said zipper assembly; and
wherein said removeably-attachable tag acts as a lever arm whereby a user can locate, grasp and manipulate said zipper upwardly and downwardly to open and close said zipper.

2. The pull tab attachment for a slide fastener system of claim 1 wherein said removeably-attachable tag comprises plastic.

3. The pull tab attachment for a slide fastener system of claim 1 wherein said removeably-attachable tag comprises wood.

4. The pull tab attachment for a slide fastener system of claim 1 wherein said removeably-attachable tag comprises a soccer ball.

5. The pull tab attachment for a slide fastener system of claim 1 wherein said removeably-attachable tag comprises a baseball.

6. The pull tab attachment for a slide fastener system of claim 1 wherein said removeably-attachable tag comprises a basketball.

7. The pull tab attachment for a slide fastener system of claim 1 wherein said removeably-attachable tag comprises a football.

8. The pull tab attachment for a slide fastener system of claim 1 wherein said removeably-attachable tag comprises a golf ball.

9. The pull tab attachment for a slide fastener system of claim 1 wherein said removeably-attachable tag comprises a logo.

10. The pull tab attachment for a slide fastener system of claim 1 wherein said removeably-attachable tag comprises indicia.

11. The pull tab attachment for a slide fastener system of claim 1 wherein said attacher is a clip.

12. The pull tab attachment for a slide fastener system of claim 12 wherein said clip measures approximately ⅞-inch.

13. The pull tab attachment for a slide fastener system of claim 12 wherein said attacher is a clasp.

14. The pull tab attachment for a slide fastener system of claim 12 wherein said attacher is a hook.

15. The pull tab attachment for a slide fastener system of claim 1 wherein said eye is circular.

16. The pull tab attachment for a slide fastener system of claim 1 wherein said eye is affixed onto said removeably-attachable tag.

17. The pull tab attachment for a slide fastener system of claim 1 wherein said eye is integral with said removeably-attachable tag when affixed thereto.

18. A pull tab attachment for a slide fastener system comprising:
a zipper assembly having;
a zipper;
a top tape extension;
a top stop;
a slider;
a pull tab;
a tape;
a bottom stop;
an insertion pin; and
a retainer box;
a removeably-attachable tag having an eye;
an attacher removeably inserted through said eye;
wherein said zipper, said top tape extension, said top stop, said slider, said pull tab, said tape, said bottom stop, said insertion pin, and said retainer box form said zipper assembly for temporarily joining two edges of fabric together;
wherein said attacher is removeably-attached via an opening/closing mechanism to an interior cut-out located on a front portion of said pull tab on said slider of said zipper assembly;
wherein said removeably-attachable tag comprises plastic;
wherein said removeably-attachable tag comprises a sports ball;
wherein said removeably-attachable tag comprises a logo;
wherein said attacher is a clip measuring approximately ⅞-inch;
wherein said attacher removeably-attaches said eye on said removeably-attachable tag to said pull tab on said slider of said zipper assembly; and
wherein said removeably-attachable tag acts as a lever arm whereby a user can locate, grasp and manipulate said zipper upwardly and downwardly to open and close said zipper.

19. The pull tab attachment for a slide fastener system of claim 18 further comprising a kit including a plurality of said removeably-attachable tags; a plurality of said attachers; and a set of user installation instructions.

20. A method of using a pull tab attachment for a slide fastener system comprising the steps of:
choosing a removeably-attachable tag having an eye;
choosing an attacher;
inserting said attacher through said eye of said removeably-attachable tag;
attaching said attacher to a pull tab on a slider of a zipper assembly;
zipping said garment via a zipper on said zipper assembly; and
unzipping said garment via said zipper on said zipper assembly.
